(19) United States
(12) Patent Application Publication
(10) Pub. No.: US 2010/0187137 A1
(43) Pub. Date: Jul. 29, 2010

(54) Oxygen-Absorbable Resin Composition, Oxygen-Absorbable Barrier Resin Composition, Oxygen-Absorbable Molded Article, Packaging Material Comprising the Molded Article, and Packaging Container

(75) Inventors: Shizuo Kitahara, Tokyo (JP); Jun Ishihara, Tokyo (JP)

Correspondence Address: BIRCH STEWART KOLASCH & BIRCH, PO BOX 747, FALLS CHURCH, VA, 22040-0747, US

(73) Assignee: ZEON CORPORATION, Tokyo (JP)

(21) Appl. No.: 12/223,990

(22) PCT Filed: Feb. 9, 2007
(86) PCT No.: PCT/JP2007/052315

§ 371 Date: Apr. 9, 2010

(30) Foreign Application Priority Data
Feb. 16, 2006 (JP) 2006-039044
Feb. 16, 2006 (JP) 2006-039045

(51) Int. Cl. B65D 81/24; B01J 20/26

(52) U.S. Cl. 206/205; 502/402

(57) ABSTRACT

[Problem to be Solved] To provide an oxygen-absorbable resin composition that does not require any metal incorporated thereinto and has excellent oxygen absorbability even at room temperature, an oxygen-absorbable barrier resin composition also exhibiting excellent gas-barrier property, oxygen-absorbable molded article comprised of the resin composition, an oxygen-absorbable packaging material comprised of the molded article, and an oxygen-absorbable packaging container.

[Means for Solving Problems] THE oxygen-absorbable resin composition comprises an oxygen-absorbable resin (A) having a cycloene structure in the molecule and a softener (B) and has a glass transition temperature of not higher than 30° C. The oxygen-absorbable barrier resin composition comprises a barrier resin (C) in addition to (A) and (B). The oxygen-absorbable resin (A) having a cycloene structure in the molecule is preferably a cyclized product of a conjugated diene polymer having an unsaturated bond reduction ratio of at least 60%. The softener (B) is preferably liquid paraffin or polybutene.

### TECHNICAL FIELD

The present invention relates to an oxygen-absorbable resin composition for use for preventing the quality deterioration by oxygen of foods, drinks, drugs and the like, and more precisely, to an oxygen-absorbable resin composition that exhibits good oxygen absorbability even at room temperature, an oxygen-absorbable barrier resin composition further having excellent gas-barrier properties, an oxygen-absorbable molded article including the resin composition, an oxygen-absorbable packaging material comprising the molded article, and an oxygen-absorbable packaging container.

### BACKGROUND ART

The quality of foods, drinks, drugs and the like is deteriorated by oxygen, and therefore they require storage in the absence of oxygen or under the condition with an extremely small amount of oxygen.

Accordingly, containers or packages stored with foods, drinks, drugs or the like are often filled with nitrogen, which however, is problematic in that, for example, the production cost may increase and that, when they are once opened, air may flow into them from the outside and thereafter they could no more prevent the quality deterioration. Therefore, various investigations have been made for absorbing oxygen remaining in containers or packages and thereby removing oxygen from them.

Recently, for resin containers or packaging materials, there has been mainly employed a method of making a resin container or a packaging material itself have oxygen absorbability.

For example, there is proposed the use of an oxygen absorbent that comprises a polyterpene such as poly(α-pinene), poly(β-pinene) or poly(dipentene), and a transition metal salt serving as an oxygen absorption catalyst such as cobalt neodecanoate or cobalt oleate (Patent Reference 1).

Also proposed is the use of an oxygen absorbent that comprises a conjugated diene polymer such as polyisoprene or 1,2-polybutadiene and a transition metal salt (Patent Reference 2).

Further proposed is the use of an oxygen-absorbent that comprises a copolymer of ethylene with cyclopentene, and a transition metal salt (Patent Reference 3).

However, these conventional oxygen absorbents are often difficult to use in some applications since the polymer may be deteriorated with the advance of oxygen absorption reaction causing their mechanical strength to lower significantly or the transition metal salt may bleed out.

### Patent Reference 1: JP-T-2001-507045

### Patent Reference 2: JP-A-2003-71992,

### Patent Reference 3: JP-T-2003-504042

### DISCLOSURE OF THE INVENTION

### Problems that the Invention is to Solve

The present inventors have noted the oxygen absorbability of a cyclized product of a conjugated diene polymer, and have made studies of its application to oxygen absorbents. Differing from the above-mentioned conventional oxygen absorbents, a cyclized product of a conjugated diene polymer has the advantage of exhibiting its excellent oxygen absorbability even in the absence of a catalyst metal.

Taking the advantage, the present inventors have developed an oxygen-absorbable resin composition that comprises a cyclized product of a conjugated diene polymer as the effective ingredient.

The inventors have grasped a fact that a resin composition comprising the above-mentioned cyclized product of a conjugated diene polymer as combined with an ethylene/vinyl alcohol copolymer or the like having low oxygen permeability may have excellent oxygen absorbability and gas-barrier properties, and have filed a patent application for it (Japanese Patent Application No. 2005-083398).

However, during the process of studies, it has been found that the oxygen-absorbable resin composition may have sufficiently excellent oxygen absorbability and gas-barrier properties at high temperatures, but at room temperature, there still remains room for further improvement on it.

Accordingly, an object of the present invention is to provide an oxygen-absorbable resin composition that does not require metal incorporated thereinto and has excellent oxygen absorbability and excellent gas-barrier properties not only at high temperatures but also at room temperature. Another object of the invention is to provide an oxygen-absorbable molded article including the above-mentioned oxygen-absorbable resin composition. Still another object of the invention is to provide an oxygen-absorbable packaging material comprising the oxygen-absorbable molded article, and an oxygen-absorbable packaging container.

### Means for Solving the Problems

The present inventors have assiduously studied for the purpose of solving the above-mentioned problems and have found that, when a specific compound is incorporated with a resin composition that comprises a cyclized product of a conjugated diene polymer as the oxygen-absorbable ingredient, then the above-mentioned object can be attained; and on the basis of this finding, the inventors have completed the present invention.

According to the invention, therefore, there is provided an oxygen-absorbable resin composition that includes an oxygen-absorbable resin (A) having a cycloene structure in the molecule and a softener (B) and has a glass transition temperature of not higher than 30° C.

According to the invention, there is also provided an oxygen-absorbable barrier resin composition including the above-mentioned oxygen-absorbable resin composition and a gas-barrier resin (C).

According to the invention, there is also provided an oxygen-absorbable molded article that includes the above-mentioned, oxygen-absorbable resin composition or oxygen-absorbable barrier resin composition.

According to the invention, there is also provided an oxygen-absorbable packaging material comprising the above-mentioned, oxygen-absorbable molded article.

According to the invention, there is also provided an oxygen-absorbable packaging container produced by shaping the above-mentioned oxygen-absorbable packaging material.

### ADVANTAGES OF THE INVENTION

The oxygen-absorbable resin composition of the invention exhibits excellent oxygen absorbability and further exhibits excellent gas-barrier properties at room temperature without requiring the use of a transition metal, and moreover does not release a bad smell after absorbing oxygen. The oxygen-absorbable molded article of the invention comprising of the above-mentioned oxygen-absorbable resin composition does not require the use of a transition metal, and is therefore highly safe with no problem in metal detection and in use in microwave ovens and the like. Accordingly, the oxygen-absorbable packaging material comprising the above-mentioned oxygen-absorbable molded article is favorable for a packaging material for various foods, chemicals, drugs, cosmetics, etc.

### BEST MODES FOR CARRYING OUT THE INVENTION

### Oxygen-Absorbable Resin Composition

The oxygen-absorbable resin composition of the invention includes an oxygen-absorbable resin (A) having a cycloene structure in the molecule and a softener (B).

The oxygen-absorbable resin (A) having a cycloene structure in the molecule for use in the invention (hereinafter this may be abbreviated as “oxygen-absorbable resin (A)”) may be an oxygen-absorbable resin having a cyclic structure with at least one double bond in the molecule, and is not specifically limited.

Its specific examples include a cyclized product of a conjugated diene polymer, a conjugated diene/aromatic vinyl compound copolymer, a ring-opening polymer and an addition polymer of an alicyclic compound, a terpene resin, and their partial hydrogenates.

Also usable are a cyclohexenylmethyl acrylate copolymer, a polyester of 1,2,3,6-tetrahydrophthalic acid or its anhydride with a glycol, and a polyester of tetrahydrophthalic acid or its anhydride with a glycol.

Of those, preferred is a cyclized product of a conjugated diene polymer.

The cyclized product of a conjugated diene polymer is obtained through cyclization of a conjugated diene polymer in the presence of an acid catalyst.

The conjugated diene polymer for use herein includes a homopolymer and a copolymer of conjugated diene monomer(s), and a copolymer of a conjugated diene monomer with a monomer copolymerizable with it.

The conjugated diene monomer is not particularly limited, and examples thereof include 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, 3-butyl-1,3-octadiene, and the like.

One or more of these monomers may be used either singly or as combined.

The monomer copolymerizable with the conjugated diene monomer includes, for example, aromatic vinyl monomers such as styrene, o-methylstyrene, p-methylstyrene, m-methylstyrene, 2,4-dimethylstyrene, ethylstyrene, p-tert-butylstyrene, α-methylstyrene, α-methyl-p-methylstyrene, o-chlorostyrene, m-chlorostyrene, p-chlorostyrene, p-bromostyrene, 2,4-dibromostyrene and vinylnaphthalene; linear olefin monomers such as ethylene, propylene and 1-butene; cyclic olefin monomers such as cyclopentene and 2-norbornene; non-conjugated diene monomers such as 1,5-hexadiene, 1,6-heptadiene, 1,7-octadiene, dicyclopentadiene and 5-ethylidene-2-norbornene; (meth)acrylate esters such as methyl (meth)acrylate and ethyl (meth)acrylate; other (meth)acrylic acid derivatives such as (meth)acrylonitrile and (meth)acrylamide; and the like.

One or more of these monomers may be used either singly or as combined.

Specific examples of the conjugated diene polymer include natural rubber (NR), styrene/isoprene rubber (SIR), styrene/butadiene rubber (SBR), polyisoprene rubber (IR), polybutadiene rubber (BR), isoprene/isobutylene copolymer rubber (IIR), ethylene/propylene/diene copolymer rubber (EPDM), butadiene/isoprene copolymer rubber (BIR), a styrene/isoprene block polymer, a styrene/butadiene block polymer, and the like. Above all, preferred are polyisoprene rubber, polybutadiene rubber and a styrene/isoprene block polymer; and more preferred are polyisoprene rubber and a styrene/isoprene block polymer. One or more of these conjugated diene polymers may be used either singly or as combined.

The content of the conjugated diene monomer unit in the conjugated diene polymer may be suitably selected within a range not detracting from the advantages of the invention, but in general, it may be at least 40 mol %, preferably at least 60 mol %, more preferably at least 80 mol %. When the content of the conjugated diene monomer unit is too small, then the unsaturated bond reduction ratio falling within a suitable range to be mentioned hereinafter may be difficult to obtain.

The conjugated diene polymer may be prepared in an ordinary polymerization method, and for example, it may be prepared through solution polymerization or emulsion polymerization using a suitable catalyst such as a Ziegler polymerization catalyst containing titanium or the like as the catalyst component, or an alkyllithium polymerization catalyst or a radical polymerization catalyst.

The cyclized product of a conjugated diene polymer to be used in the invention may be prepared through cyclization of the above-mentioned conjugated diene polymer in the presence of an acid catalyst.

The acid catalyst for use in the cyclization may be any known one. Its specific examples include sulfuric acid; organic sulfonic acid compounds such as fluoromethanesulfonic acid, difluoromethanesulfonic acid, p-toluenesulfonic acid, xylenesulfonic acid, alkylbenzenesulfonic acids having an alkyl group with from to 18 carbon atoms, and their anhydrides and alkyl esters; Lewis acids such as boron trifluoride, boron trichloride, tin tetrachloride, titanium tetrachloride, aluminum chloride, diethylaluminum monochloride, ethylammonium chloride, aluminum bromide, antimony pentachloride, tungsten hexachloride and iron chloride; and the like. One or more of these acid catalysts may be used either singly or as combined. Above all, preferred are organic sulfonic acid compounds; and more preferred are p-toluenesulfonic acid and xylenesulfonic acid.

The amount of the acid catalyst to be used may be generally from 0.05 to 10 parts by weight per 100 parts by weight of the conjugated diene polymer, preferably from 0.1 to 5 parts by weight, more preferably from 0.3 to 2 parts by weight.

In general, the conjugated diene polymer is dissolved in a hydrocarbon solvent for its cyclization.

The hydrocarbon solvent is not particularly limited, and may be any one not interfering with the cyclization, including, for example, aromatic hydrocarbons such as benzene, toluene, xylene and ethylbenzene; aliphatic hydrocarbons such as n-pentane, n-hexane, n-heptane and n-octane; alicyclic hydrocarbons such as cyclopentane and cyclohexane; and the like. Preferably, the boiling point of those hydrocarbon solvents is not lower than 70° C.

The solvent for the polymerization to give the conjugated diene polymer and the solvent for the cyclization may be the same type. In this case, an acid catalyst for cyclization may be added to the polymerization reaction liquid after polymerization, whereby the cyclization may be carried out successively after the polymerization.

The amount of the hydrocarbon solvent to be used may be such that the solid concentration of the conjugated diene polymer therein could be generally from 5 to 60% by weight, preferably from 20 to 40% by weight.

The cyclization may be carried out under pressure or under reduced pressure, or under atmospheric pressure, but from the viewpoint of the simplicity in operation, it is carried out preferably under atmospheric pressure. The cyclization in a dry stream, especially in an atmosphere of dry nitrogen or dry argon may prevent side reactions to be caused by moisture.

The reaction temperature and the reaction time in the cyclization are not specifically defined. The reaction temperature may be generally from 50 to 150° C., preferably from 70 to 110° C.; and the reaction time may be generally from 0.5 to 10 hours, preferably from 2 to 5 hours.

After the cyclization, the acid catalyst is inactivated in an ordinary manner, then the acid catalyst residue is removed, and thereafter the hydrocarbon solvent is removed, whereby a solid cyclized product of a conjugated diene polymer is obtained.

In the invention, especially preferred is the use of a cyclized product of a conjugated diene polymer having an unsaturated bond reduction ratio of at least 60%.

The use of a cyclized product of a conjugated diene polymer having an unsaturated bond reduction ratio of at least 60% makes it possible to prevent bad smell release in oxygen absorption.

The unsaturated bond reduction ratio of the cyclized product of a conjugated diene polymer is preferably from 60 to 80%, more preferably from 63 to 80%, even more preferably from 65 to 75%. The unsaturated bond reduction ratio of the cyclized product of a conjugated diene polymer may be controlled by suitably selecting the amount of the acid catalyst, the reaction temperature and the reaction time in cyclization.

Suitable definition of the unsaturated bond reduction ratio of the cyclized product of a conjugated diene polymer enables the resin composition to have a glass transition temperature falling within a suitable range, therefore resulting in that the resin composition may exhibit excellent oxygen absorbability and may prevent bad smell release in oxygen absorption. When the unsaturated bond reduction ratio is too low, then the quantity of bad smell release in oxygen absorption may increase; and a cyclized product of a conjugated diene polymer having too large an unsaturated bond reduction ratio may be difficult to produce, and only a brittle one could be obtained.

The unsaturated bond reduction ratio as referred to herein is an index that indicates the degree of unsaturated bond reduction through cyclization in the conjugated diene monomer unit segment in the conjugated diene polymer; and its value is determined in the manner mentioned below. Specifically, in the conjugated diene monomer unit segment in a conjugated diene polymer, the ratio of the peak area of the protons directly bonding to the double bond to the peak area of all protons is determined through proton NMR analysis before and after cyclization, and the reduction ratio is computed from the data.

In the conjugated diene monomer unit segment in a conjugated diene polymer, when the overall proton peak area and the peak area of the protons directly bonding to the double bond before cyclization are represented by SBT and by SBU, respectively, and the overall proton peak area and the peak area of the protons directly bonding to the double bond after cyclization are represented by SAT and by SAU, respectively, then the peak area ratio (SB) of the protons directly bonding to the double bond before cyclization is:

SB=SBU/SBT,

and the peak area ratio (SA) of the protons directly bonding to the double bond after cyclization is:

SA=SAU/SAT.

Accordingly, the unsaturated bond reduction ratio is determined according to the following expression:

Unsaturated bond reduction ratio (%)=100×(SB−SA)/SB.

The weight-average molecular weight of the cyclized product of a conjugated diene polymer may be generally from 1,000 to 1,000,000, in terms of standard polystyrene measured through gel permeation chromatography, preferably from 10,000 to 700,000, more preferably from 30,000 to 500,000. The weight-average molecular weight of the cyclized product of a conjugated diene polymer may be controlled by suitably selecting the weight-average molecular weight of the conjugated diene polymer to be cyclized.

Suitable definition of the weight-average molecular weight of the cyclized product of a conjugated diene polymer betters the film shapability of the resin composition and betters the mechanical strength thereof. In addition, the solution viscosity in cyclization may be suitable and the processability in extrusion may be kept good.

The gel (toluene-insoluble) content of the cyclized product of a conjugated diene polymer may be generally at most 10% by weight, preferably at most 5% by weight, but more preferably the cyclized product contains substantially no gel. When the gel content is too high, then the film may lose smoothness.

In the invention, an antioxidant, if any, in the cyclized product of a conjugated diene polymer may detract from the oxygen absorbability of the cyclized product of a conjugated diene polymer, and preferably, therefore, the cyclized product of a conjugated diene polymer contains substantially no antioxidant. However, for securing the stability of the cyclized product of a conjugated diene polymer in processing and for controlling the oxygen absorbability thereof, an antioxidant may be added to the cyclized product in an amount of at most 8,000 ppm, preferably from 30 ppm to 5,000 ppm, more preferably from 50 ppm to 3,000 ppm.

The antioxidant is not particularly limited and may be any one generally used in the field of resin materials or rubber materials. Typical examples of the antioxidant include hindered phenolic antioxidants, phosphorus-containing antioxidants and lactone-based antioxidants. Two or more types of such antioxidants may be used as combined.

Specific examples of the hindered phenolic antioxidants are 2,6-di-t-butyl-p-cresol, pentaerythritol tetrakis[3-(3,5-di-t-butyl-4-hydroxyphenyl)propionate], thiodiethylenebis[3-(3,5-di-t-butyl-4-hydroxyphenyl)propionate], octadecyl 3-(3,5-di-t-butyl-4-hydroxyphenyl)propionate, N,N′-hexane-1,6-diylbis[3-(3,5-di-t-butyl-4-hydroxyphenyl)propionamide], diethyl [[3,5-bis(1,1-dimethylethyl)-4-hydroxyphenyl]methyl]phosphonate, 3,3′,3″, 5,5′,5″-hexa-t-butyl-a,a′,a″-(mesitylene-2,4,6-triyl)tri-p-cresol, hexamethylenebis[3-(3,5-di-t-butyl)-4-hydroxyphenyl]propionate, tetrakis[methylene-3-(3,5-di-t-butyl-4-hydroxyphenyl)propionate]methane, n-octadecyl (4′-hydroxy-3,5′-di-t-butylphenyl)propionate, 1,3,5-tris(3,5-di-t-butyl-4-hydroxybenzyl)-1,3,5-triazine-2,4,6(1H,3H,5H)-trione, 2,4-bis(n-octylthio)-6-(4-hydroxy-3,5-di-t-butylanilino)-1,3,5-triazine, tris(3,5-di-t-butyl-4-hydroxybenzyl) isocyanurate, 2-t-butyl-6-(3-t-butyl-2-hydroxy-5-methylbenzyl)-4-methylphenyl acrylate, 2-[1-(2-hydroxy-3,5-di-t-phenylbutyl)ethyl]-4,6-di-t-pentylphenyl acrylate, and the like.

The phosphorus-containing antioxidants include tris(2,4-di-t-butylphenyl) phosphite, bis[2,4-bis(1,1-dimethylethyl)-6-methylphenyl]ethyl phosphite, tetrakis(2,4-di-t-butylphenyl)[1,1-biphenyl]-4,4′-diyl bisphosphonite, bis(2,4-di-t-butylphenyl)pentaerythritol phosphite, 4,4′-butylidenebis(3-methyl-6-t-butylphenyl-ditridecyl phosphite), and the like.

A lactone-based antioxidant, which is a reaction product of 5,7-di-t-butyl-3-(3,4-dimethylphenyl)-3H-benzofuran-2-one or the like with o-xylene, may also be used, as combined with the above.

In addition, if desired, various compounds generally added thereto may be added to the cyclized product of a conjugated diene polymer. The compounds may be those generally used in adhesives, and include a filler such as calcium carbonate, alumina and titanium oxide; a tackifier (hydrogenated petroleum resins, hydrogenated terpene resins, castor oil derivatives, sorbitan higher fatty acid esters); a plasticizer (phthalate esters, glycol esters); a surfactant; a leveling agent; a UV absorbent; a light stabilizer; an aldehyde adsorbent such as an alkylamine or an amino acid; a dehydrating agent; a pot life extender (acetylacetone, methanol, methyl orthoacetate); a cissing-improving agent; and the like.

The oxygen-absorbable resin composition of the invention may include any other known oxygen-absorbable component than the oxygen-absorbable resin (A), so far as it does not detract from the advantages of the invention. The amount of the other oxygen-absorbable component than the oxygen-absorbable resin (A) may be less than 50% by weight relative to the whole amount of the oxygen-absorbable components (the total amount of the oxygen-absorbable resin (A) and the other oxygen-absorbable component than it), preferably less than 40% by weight, more preferably less than 30% by weight.

The oxygen-absorbable resin composition of the invention comprises a softener (B) as the indispensable ingredient.

The softener (B) must be compatible with the oxygen-absorbable resin (A).

The softener (B) for use in the invention must be capable of making the oxygen-absorbable resin composition of the invention have a glass transition temperature of not higher than 30° C. The lowermost limit of the glass transition temperature of the oxygen-absorbable resin composition comprising the oxygen-absorbable resin (A) and the softener (B) is preferably −30° C. When the glass transition temperature is too low, then the amount of the softener (B) in the composition may be too much and the oxygen absorbability of the composition may lower.

The softener (B) is not particularly limited so far as it satisfies the above-mentioned requirement, but preferably, it is a fluid having by itself a glass transition temperature or a pour point of not higher than −30° C.

Specific examples of the softener (B) include hydrocarbon oils such as isoparaffin oil, naphthene oil and liquid paraffin; olefin polymers such as polybutene; hydrogenated products of conjugated diene polymers such as polyisoprene and polybutadiene; hydrogenated products of styrene/conjugated diene polymers, and the like.

One or more of these softeners may be used either singly or as combined.

Of those, preferred are hydrocarbon oils and olefin polymers; and more preferred are liquid paraffin and polybutene.

In the oxygen-absorbable resin composition of the invention, the ratio of the oxygen-absorbable resin (A) to the softener (B) may depend on the glass transition temperature of the oxygen-absorbable resin (A) therein but is not particularly limited so far as the glass transition temperature of the resultant oxygen-absorbable resin composition could be 30° C. or lower.

For example, when a cyclized polyisoprene having an unsaturated bond reduction ratio of 68% is used as the oxygen-absorbable resin (A) and liquid paraffin is used as the softener (B), then the weight of liquid paraffin is preferably within a range of at least 15% of the total weight of the oxygen-absorbable resin (A) and liquid paraffin.

The blend ratio of the softener (B) is preferably within a range of from 15 to 80% by weight relative to the total weight of the oxygen-absorbable resin (A) and the softener (B), more preferably from 15 to 40% by weight.

When the ratio by weight of the oxygen-absorbable resin (A) to the softener (B) falls within the above range, then the oxygen absorbability of the resultant oxygen-absorbable resin composition may be good.

The oxygen-absorbable resin composition of the invention may contain any other polymer than the oxygen-absorbable resin (A).

The other polymer than the oxygen-absorbable resin (A) is not particularly limited, and may be a rubber such as polybutadiene, polyisoprene or a styrene/butadiene copolymer, but is preferably a resin.

The resin is not particularly limited and may be a thermosetting resin such as a urea resin; a melamine resin; a phenolic resin; an alkyd resin; an unsaturated polyester resin; an epoxy resin; a diallyl phthalate resin; an amino resin such as polyallylamine; however, a thermoplastic resin is preferred.

The thermoplastic resin is not particularly limited, and specific examples thereof include poly-α-olefin resins; aromatic vinyl resins such as polystyrene; vinyl halide resins such as polyvinyl chloride; polyvinyl alcohol resins such as polyvinyl alcohol and an ethylene/vinyl alcohol copolymer; fluororesins; acrylic resins such as a methacrylic resin; polyamide resins such as nylon 6, nylon 66, nylon 610, nylon 11, nylon 12 and their copolymers; polyester resins such as polyethylene terephthalate and polybutylene terephthalate; polycarbonate resins; polyurethane resins; and the like. Of those, preferred are poly-α-olefin resins.

The poly-α-olefin resin may be any of α-olefin homopolymers, copolymers of two or more α-olefins, or copolymers of an α-olefin with a monomer other than α-olefin, and may be modified derivatives from those (co)polymers.

Its specific examples include homopolymers or copolymers of an α-olefin such as ethylene or propylene, for example, low-density polyethylene, middle-density polyethylene, high-density polyethylene, linear low-density polyethylene, metallocene polyethylene, polypropylene, metallocene polypropylene, polymethylpentene; copolymers of ethylene with an α-olefin, for example, random or block ethylene/propylene copolymers; α-olefin copolymers mainly composed of an α-olefin, of an α-olefin with vinyl acetate, an acrylate ester, a methacrylate ester or the like, for example, poly-α-olefin resins such as an ethylene/vinyl acetate copolymer, an ethylene/ethyl acrylate copolymer, an ethylene/methyl methacrylate copolymer, an ethylene/acrylic acid copolymer and an ethylene/methacrylic acid copolymer; acid-modified poly-α-olefin resins prepared by modifying an α-olefin (co)polymer such as polyethylene or polypropylene with an unsaturated carboxylic acid such as acrylic acid, methacrylic acid, maleic acid, maleic anhydride, fumaric acid or itaconic acid; ionomer resins prepared by processing an ethylene/methacrylic acid copolymer or the like with a Na ion or a Zn ion; their mixtures; and the like.

Of those, preferred is polyethylene, polypropylene, and random or block ethylene/propylene copolymers.

The amount of the other polymer than the oxygen-absorbable resin (A) is preferably less than 70% by weight of the total weight of the polymer and the oxygen-absorbable resin (A), more preferably not more than 60% by weight. Its lowermost limit is preferably 5% by weight, more preferably 10% by weight. When the content of the oxygen-absorbable resin (A) is too small, then it may detract from the oxygen absorbability.

To the oxygen-absorbable resin composition of the invention, optionally added are a heat stabilizer; a UV absorbent; an antioxidant; a colorant; a pigment; a neutralizing agent; a plasticizer such as a phthalate ester or a glycol ester; a filler; a surfactant; a leveling agent; a light stabilizer; a dehydrating agent such as an alkaline earth metal oxide; a deodorant such as activated carbon or zeolite; a tackifier (castor oil derivatives, sorbitan higher fatty acid esters); a pot life extender (acetylacetone, methanol, methyl orthoacetate, or the like.); a cissing-improving agent and the like, within a range not detracting from the object of the invention.

If desired, an anti-blocking agent, an antifogging agent, a heat-resistant stabilizer, a weather-resistant stabilizer, a lubricant, an antistatic agent, a reinforcing agent, a flame retardant, a coupling agent, a blowing agent, a releasing agent or the like may be added to the composition.

The oxygen-absorbable resin composition of the invention has an oxygen absorption rate at 25° C. of preferably at least 0.3 cc/g·day, more preferably at least 5 cc/g·day. Its uppermost limit is preferably 50 cc/g·day, more preferably 40 cc/g·day, even more preferably 30 cc/g·day.

The method for preparing the oxygen-absorbable resin composition of the invention is not particularly limited, for which, for example, the oxygen-absorbable resin (A), the softener (B), and optionally other resin and various additives may be mixed in any desired method. The order of mixing them is not particularly limited. The ingredients may be mixed all at a time, or some of them are previously mixed and the remaining ingredient may be mixed with it. The kneading device is not particularly limited, and concretely, various kneading devices are usable, for example, a single-screw extruder or a multi-screw extruder such as a twin-screw extruder, a Banbury mixer, a roller, a kneader, and the like. The mixing temperature preferably falls within a range of from 150 to 250° C.

### (Oxygen-Absorbable Barrier Resin Composition)

When a gas-barrier resin (C) is selected as the indispensable ingredient of the other polymer than the oxygen-absorbable resin (A) to be incorporated with the oxygen-absorbable resin composition of the invention, then an oxygen-absorbable barrier resin composition having excellent gas-barrier properties in addition to excellent oxygen absorbability may be obtained.

The oxygen-absorbable barrier resin composition of the invention comprises the above-mentioned oxygen-absorbable resin composition and a gas-barrier resin (C). The oxygen-absorbable barrier resin composition of the invention comprises an oxygen-absorbable resin (A), a softener (B) and a gas-barrier resin (C) as essential ingredients, in which the oxygen-absorbable resin composition comprising the oxygen-absorbable resin (A) and the softener (B) has a glass transition temperature of not higher than 30° C.

The gas-barrier resin (C) is not particularly limited so far as it has gas-barrier properties.

The gas-barrier resin (C) is preferably a resin having an oxygen permeation rate of from 0.15 to 20 cc/m²·day·atm (20 μm, 23° C., 65% RH). Specifically, the oxygen permeation rate of the gas-barrier resin must be from 0.15 to 20 cc/m²·day·atm, as measured in the form of its film having a thickness of 20 μm under the condition of 23° C. and a relative humidity of 65%. In other words, the volume of oxygen that permeates a day through the resin film having a thickness of 20 μm and an area of 1 m², as measured under the condition of the above-mentioned temperature and humidity and under the condition of a pressure difference of 1 atmosphere, must be from 0.15 to 20 cc.

Preferred examples of the gas-barrier resin include an ethylene/vinyl alcohol copolymer, a vinylidene chloride resin, a polyamide resin and a polyaramide resin.

The ethylene/vinyl alcohol copolymer is a copolymer structurally comprising ethylene and vinyl alcohol as the main constitutive units, but in fact, it may be obtained by partially or completely saponifying a copolymer of ethylene with a vinyl ester of a fatty acid with an alkali catalyst or the like.

The vinyl ester of a fatty acid to be copolymerized with ethylene is typically vinyl acetate, and apart from it, vinyl propionate, vinyl pivalate or the like may also be used. The ethylene/vinyl alcohol copolymer for use in the invention is not particularly limited by the saponification method.

In the ethylene/vinyl alcohol copolymer, the ethylene content is preferably at least 15 mol %, more preferably from 20 to 50 mol %, even more preferably from 30 to 45 mol %, still more preferably from 35 to 45 mol %. The ethylene content may be determined by a method of nuclear magnetic resonance (NMR).

When the ethylene content falls within the range, then the compatibility of the copolymer with the oxygen-absorbable resin composition (A) may be good, and the gas-barrier properties of the resultant oxygen-absorbable resin composition may be therefore excellent.

One or more of ethylene/vinyl alcohol copolymers may be used either singly or as combined.

When two or more ethylene/vinyl alcohol copolymers, each having a different ethylene content, are combined for use herein, the ethylene content of the ethylene/vinyl alcohol copolymer mixture may be obtained from the blend ratio by weight of the combined copolymers.

The degree of saponification of the vinyl ester segment in the ethylene/vinyl alcohol copolymer (ratio of the monomer unit segment having a vinyl alcohol structure to the total of the monomer unit segment having a vinyl alcohol structure and the monomer unit segment having a vinyl ester structure) is preferably at least 90 mol %, more preferably at least 95 mol %, even more preferably at least 97 mol %.

The degree of saponification may be determined according to a method of nuclear magnetic resonance (NMR).

When the degree of saponification of the ethylene/vinyl alcohol copolymer falls within the above-mentioned range, then the resin composition that comprises a cyclized product of a conjugated diene polymer and the ethylene/vinyl alcohol copolymer, obtained by using the copolymer, may have excellent gas-barrier properties. In addition, the ethylene/vinyl alcohol copolymer has good thermal stability, and the molded articles of the resin composition obtained by using the copolymer do not contain impurities such as gels and fisheyes.

In case where two or more copolymers having a different degree of saponification are combined, the degree of saponification of the ethylene/vinyl alcohol copolymer mixture may be determined from the blend ratio by weight of the copolymers combined.

Specific examples of the polyamide resin usable as the gas-barrier resin include nylon 6, nylon 66, nylon 610, nylon 11, nylon 12, MXD nylon (polymetaxylylene adipamide), and their copolymers and the like.

In the oxygen-absorbable barrier resin composition of the invention, the ratio, (A+B)/(C), by weight of the total of the oxygen-absorbable resin (A) and the softener (B) to the gas-barrier resin (C) is preferably within a range of from 50/50 to 5/95, more preferably from 40/60 to 20/80.

When the ratio by weight of the total of the oxygen-absorbable resin (A) and the softener (B) to the gas-barrier resin (C) is within the above range, then the oxygen absorbability and the gas-barrier properties of the resultant oxygen-absorbable barrier resin composition may be good.

In the oxygen-absorbable barrier resin composition of the invention, the gas-barrier resin (C) preferably forms a matrix resin layer. Owing to this structure, the layer of the oxygen-absorbable resin composition comprising the oxygen-absorbable resin (A) and the softener (B) may efficiently absorb the oxygen having passed through the matrix resin layer, therefore enhancing the gas-barrier properties of the entire oxygen-absorbable barrier resin composition.

Accordingly, the proportion of the gas-barrier resin (C) in the oxygen-absorbable barrier resin composition is preferably from 50 to 90% by weight, more preferably from 55 to 80% by weight.

Incorporation of a poly-α-olefin resin with the oxygen-absorbable barrier resin composition of the invention realizes excellent handleability of the oxygen-absorbable barrier resin composition of the invention.

The poly-α-olefin resin may be the same as those mentioned in the above for the oxygen-absorbable resin composition.

Of the poly-α-olefin resins, preferred are polyethylene, polypropylene, and a random or block ethylene/propylene copolymer.

The content of the poly-α-olefin resin is preferably from 10 to 150 parts by weight relative to 100 parts by weight of the oxygen-absorbable resin (A), more preferably from 30 to 100 parts by weight.

The oxygen-absorbable barrier resin composition of the invention may further contain any other resin than the oxygen-absorbable resin (A), the gas-barrier resin (C) and the poly-α-olefin resin. Its amount is not particularly limited so far as it does not detract from the advantages of the invention, but is preferably at most 20% by weight relative to the whole amount of the oxygen-absorbable barrier resin composition.

Specific examples of the other resin include polyester resins such as polyethylene terephthalate and polybutylene terephthalate; polycarbonate resins; polystyrene resins; polyacetal resins; fluororesins; polyether-based, adipate ester-based, caprolactone ester-based or polycarbonate ester-based thermoplastic polyurethanes; polyvinyl alcohol; their mixtures; and the like.

The additionally-incorporable resin may be suitably selected in accordance with the object of the oxygen-absorbable barrier resin composition and in consideration of the desired necessary properties thereof, for example, gas-barrier properties, mechanical properties such as strength, toughness and rigidity, as well as heat resistance, printability, transparency, adhesiveness, and the like. One or more of these resins may be used either singly or as combined.

Various additives incorporable with the above-mentioned oxygen-absorbable resin composition may be added to the oxygen-absorbable barrier resin composition of the invention within a range not detracting from the object of the invention.

The oxygen-absorbable barrier resin composition of the invention drastically lowers the oxygen permeation rate of the gas-barrier resin (C) used therein. Its oxygen permeation rate may differ, depending on the type of the gas-barrier resin (C) used therein, but is preferably from 0.0001 to 1 cc/m²·day·atm (20 μm, 23° C., 65% RH), more preferably from 0.001 to 0.5 cc/m²·day·atm (20 μm, 23° C., 65% RH), even more preferably from 0.001 to 0.1 cc/m²·day·atm (20 μm, 23° C., 65% RH).

The method for preparing the oxygen-absorbable barrier resin composition of the invention is not particularly limited, and the composition may be prepared according to the preparation method for the oxygen-absorbable resin composition mentioned in the above.

### (Oxygen-Absorbable Molded Article)

The oxygen-absorbable molded article of the invention is comprised of the above-mentioned oxygen-absorbable resin composition of the invention (including a case of using the oxygen-absorbable barrier resin composition of the invention).

The oxygen-absorbable molded article of the invention can be produced from the resin composition of the invention according to a known molding method.

The oxygen-absorbable molded article of the invention may have a form of a film.

Strictly speaking, “films” and “sheets” may be differentiated by their thickness, but in this invention, the film has a concept that includes both “films” and “sheets”.

The oxygen-absorbable molded article of the invention having a form of a film (hereinafter referred to as “oxygen-absorbable film”) may be produced from the oxygen-absorbable resin composition of the invention according to a known method. For example, the film may be produced according to a solution-casting method that comprises dissolving the oxygen-absorbable resin composition in a solvent and then casting the solution onto a nearly flat face and drying it thereon. In addition, for example, the oxygen-absorbable resin composition may be melt-kneaded in an extruder, then extruded out through a T-die, a circular die (ring die) or the like to give a predetermined shape, thereby producing a T-die film, a blown film or the like. As the extruder, usable is a melt-kneading machine such as a single-screw extruder, a twin-screw extruder or a Banbury mixer. The T-die film may be biaxially stretched to give a biaxially stretched film.

The oxygen-absorbable molded article of the invention has a layer comprising the above-mentioned oxygen-absorbable resin composition of the invention.

A preferred example of the oxygen-absorbable molded article is a multilayer film having a layer that comprises the oxygen-absorbable resin composition (hereinafter the layer may be referred to as “oxygen-absorbable resin composition layer”, and the film may be referred to as “oxygen-absorbable multilayer film”).

The oxygen-absorbable multilayer film of the invention has at least a layer that comprises the oxygen-absorbable resin composition of the invention.

The other layer than the layer comprising the oxygen-absorbable resin composition is not particularly limited, but its examples include a sealing material layer, a protective layer, an adhesive layer, and the like. In case where the oxygen-absorbable resin composition contains the gas-barrier resin (C), the oxygen-absorbable multilayer film comprising it may have excellent gas-barrier properties, but it may be additionally provided with some other gas-barrier material layer.

The oxygen-absorbable resin composition layer of the oxygen-absorbable multilayer film of the invention absorbs oxygen from the outside (in case where the film is provided with a gas-barrier material layer, it absorbs oxygen from the outside having passed through the gas-barrier material layer). When a packaging material that is comprised of the oxygen-absorbable multilayer film is formed into, for example, a bag-shaped packaging container, the resin composition layer is to be a layer that has the function of absorbing the oxygen inside the packaging container via the oxygen-permeable layer (sealing material layer) thereof.

In the oxygen-absorbable resin composition layer of the oxygen-absorbable multilayer film of the invention, the total amount of the oxygen-absorbable resin (A) and the softener (B) (in case where the composition contains the gas-barrier resin (C), the total amount of the oxygen-absorbable resin (A), the softener (B) and the gas-barrier resin (C)) is preferably at least 20% by weight relative to all the constitutive ingredients of the oxygen-absorbable resin composition layer, more preferably at least 30% by weight.

The gas-barrier material layer is a layer to be provided for preventing permeation of gases from the outside. The gas-barrier material layer is to be an outer layer when the oxygen-absorbable multilayer film is formed, for example, into a bag-shaped packaging material. The oxygen permeation rate of the gas-barrier material layer is preferably as low as possible, so far as the processability and the cost permit it; and irrespective of its thickness, the layer must have an oxygen permeation rate of at most 100 cc/m²·atm·day (25° C., 100% RH), more preferably at most 50 cc/m²·atm·day (25° C., 100% RH).

The material to constitute the gas-barrier material layer is not particularly limited, so far as it has low permeability to gases (e.g., oxygen, steam), for which, for example, usable are metals, inorganic materials, resins, or the like.

As the metal, generally used is aluminum having low gas permeability. The metal may be laminated on a resin film or the like as foil thereon, or a thin metal film may be formed on a resin film or the like through vapor deposition thereon.

As the inorganic material, usable is a metal oxide such as silica or alumina. One or more such metal oxides may be used either singly or as combined, and may be deposited on a resin film or the like by vapor deposition thereon.

Though not comparable to metals and inorganic materials in point of their gas-barrier properties, resins may have many choices in points of mechanical properties, thermal properties, chemical resistance, optical properties and production methods; and because of such advantages, resins are favorably used as the gas-barrier material. The resins usable for the gas-barrier material layer in the invention are not particularly limited, and may be any ones having good gas-barrier properties; and chlorine-free resins are favorable as not generating harmful gas on incineration.

Of those, preferred for use herein is a transparent vapor-deposition film produced by vapor deposition of an inorganic oxide on a resin film.

Specific examples of the resins for use in the gas-barrier material layer include polyvinyl alcohol resins such as polyvinyl alcohol and an ethylene/vinyl alcohol copolymer; polyester resins such as polyethylene terephthalate and polybutylene terephthalate; polyamide resins such as nylon 6, nylon 66, nylon 610, nylon 11, nylon 12, MXD nylon (polymetaxylylene adipamide) and their copolymers; polyaramide resins; polycarbonate resins; polystyrene resins; polyacetal resins; fluororesins; polyether-based, adipate ester-based, caprolactone ester-based or polycarbonate ester-based thermoplastic polyurethanes; vinyl halide resins such as polyvinylidene chloride and polyvinyl chloride; polyacrylonitriles; copolymers of an α-olefin with vinyl acetate, an acrylate ester or an methacrylate ester, for example, poly-α-olefin resins such as an ethylene/vinyl acetate copolymer, an ethylene/ethyl acrylate copolymer, an ethylene/methyl methacrylate copolymer, an ethylene/acrylic acid copolymer and an ethylene/methacrylic acid copolymer; acid-modified poly-α-olefin resins prepared by modifying an α-olefin (co)polymer such as polyethylene or polypropylene with an unsaturated carboxylic acid such as acrylic acid, methacrylic acid, maleic acid, maleic anhydride, fumaric acid or itaconic acid; ionomer resins prepared by processing an ethylene/methacrylic acid copolymer or the like with a Na ion or a Zn ion; their mixtures; and the like. An inorganic oxide such as aluminum oxide or silicon oxide may be vapor-deposited on the gas-barrier material layer.

These resins may be suitably selected in accordance with the object of the intended multilayer film and in consideration of the desired necessary properties thereof, for example, gas-barrier properties, mechanical properties such as strength, toughness and rigidity, as well as heat resistance, printability, transparency, adhesiveness, or the like. One or more of these resins may be used either singly or as combined.

To the resin for use in the gas-barrier material layer, optionally added are a heat stabilizer; a UV absorbent; an antioxidant; a colorant; a pigment; a neutralizing agent; a plasticizer such as a phthalate ester or a glycol ester; a filler; a surfactant; a leveling agent; a light stabilizer; a dehydrating agent such as an alkaline earth metal oxide; a deodorant such as activated carbon or zeolite; a tackifier (castor oil derivatives, sorbitan higher fatty acid esters, low-molecular polybutenes); a pot life extender (acetylacetone, methanol, methyl orthoacetate, and the like.); a cissing-improving agent; other resins (poly-α-olefins, and the like.); and the like.

If desired, an anti-blocking agent, an antifogging agent, a heat-resistant stabilizer, a weather-resistant stabilizer, a lubricant, an antistatic agent, a reinforcing agent, a flame retardant, a coupling agent, a blowing agent, a releasing agent or the like may be added to the layer.

A protective layer may be formed outside the gas-barrier material layer for imparting heat resistance.

The resin for use in the protective layer includes ethylene polymers such as high-density polyethylene; propylene polymers such as a propylene homopolymer, a propylene/ethylene random copolymer and a propylene/ethylene block copolymer; polyamides such as nylon 6 and nylon 66; polyesters such as polyethylene terephthalate; and the like. Of those, preferred are polyamides and polyesters.

In case where a polyester film, a polyamide film, an inorganic oxide-deposited film, a vinylidene chloride-coated film or the like is used as the gas-barrier material layer, the gas-barrier material layer of the type additionally functions as a protective layer.

In the oxygen-absorbable multilayer film of the invention, the sealing material layer is a layer that has the function of melting under heat to mutually adhere to each other (heat seal) to thereby form, inside a packaging container, a space that is shielded from the outside of the packaging container, and permits oxygen to transmit it so as to be absorbed by the oxygen-absorbable resin composition layer while preventing direct contact of the oxygen-absorbable resin composition layer with the packaged subject inside the packaging container.

Specific examples of the heat-sealable resin for use in the formation of the sealing material layer include homopolymers of an α-olefin such as ethylene or propylene, for example, low-density polyethylene, middle-density polyethylene, high-density polyethylene, linear low-density polyethylene, metallocene polyethylene, polypropylene, polymethylpentene and polybutene; ethylene/α-olefin copolymers, for example, ethylene/propylene copolymer; α-olefin copolymers mainly composed of an α-olefin, of an α-olefin with vinyl acetate, an acrylate ester, a methacrylate ester or the like, for example, poly-α-olefin resins such as an ethylene/vinyl acetate copolymer, an ethylene/ethyl acrylate copolymer, an ethylene/methyl methacrylate copolymer, an ethylene/acrylic acid copolymer and an ethylene/methacrylic acid copolymer; acid-modified poly-α-olefin resins prepared by modifying an α-olefin (co)polymer such as polyethylene or polypropylene with an unsaturated carboxylic acid such as acrylic acid, methacrylic acid, maleic acid, maleic anhydride, fumaric acid or itaconic acid; ionomer resins prepared by processing an ethylene/methacrylic acid copolymer or the like with a Na ion or a Zn ion; their mixtures; and the like.

To the heat-sealable resin, if desired, optionally added are an antioxidant; a tackifier (hydrogenated petroleum resins, hydrogenated terpene resins, castor oil derivatives, sorbitan higher fatty acid esters, low-molecular polybutenes, and the like.); an antistatic agent; a filler; a plasticizer (phthalate esters, glycol esters, and the like.); a surfactant; a leveling agent; a heat-resistant stabilizer; a weather-resistant stabilizer; a UV absorbent; a light stabilizer; a dehydrating agent; a pot life extender (acetylacetone, methanol, methyl orthoacetate, and the like.); a cissing-improving agent; an anti-blocking agent; an antifogging agent; a lubricant; a reinforcing agent; a flame retardant; a coupling agent; a blowing agent; a releasing agent; a colorant; a pigment; or the like.

The antioxidant may be the same as those that may be added to the cyclized product of a conjugated diene polymer.

The anti-blocking agent includes silica, calcium carbonate, talc, zeolite, starch, and the like. The anti-blocking agent may be kneaded in a resin or may be adhered to the surface of a resin.

The antifogging agent includes higher fatty acid glycerides such as diglycerin monolaurate, diglycerin monopalmitate, diglycerin monooleate, diglycerin dilaurate and triglycerin monooleate; polyethylene glycol higher fatty acid esters such as polyethylene glycol oleate, polyethylene glycol laurate, polyethylene glycol palmitate and polyethylene glycol stearate; polyoxyethylene higher fatty acid alkyl ethers such as polyoxyethylene lauryl ether and polyoxyethylene oleyl ether; and the like.

The lubricant includes higher fatty acid amides such as stearamide, oleamide, erucamide, behenamide, ethylenebisstearamide and ethylenebisoleamide; higher fatty acid esters; wax; and the like.

The antistatic agent includes glycerin esters, sorbitan acid esters or polyethylene glycol esters of higher fatty acids, and the like.

The reinforcing agent includes metal fibers, glass fibers, carbon fibers, and the like.

The flame retardant includes phosphate esters, halogenated phosphate esters, halides, and the like.

The coupling agent includes silane-based, titanate-based, chromium-based and aluminum-based coupling agents.

The colorant and the pigment include phthalocyanine-based, indigo-based, quinacridone-based, metal complex-based and other various azo dyes; basic and acidic water-soluble dyes; azo-based, anthraquinone-based or perylene based oil-soluble dyes; titanium oxide, iron oxide, composite oxide and other various metal oxides; and chromate-based, sulfide-based, silicate-based, carbonate-based and other various inorganic pigments.

The blowing agent includes methylene chloride, butane, azobisisobutyronitrile, and the like.

The releasing agent includes polyethylene wax, silicone oil, long-chain carboxylic acids, metal salts of long-chain carboxylic acids, and the like.

The oxygen-absorbable multilayer film of the invention preferably comprises the gas-barrier material layer, the oxygen-absorbable resin composition layer and the sealing material layer as laminated in that order, but may further has the outer protective layer mentioned above, and in addition, if desired, for example, an adhesive layer comprised of polyurethane may be provided between the constitutive layers, and a thermoplastic resin layer may also be provided.

The overall thickness of the multilayer film of the invention is preferably less than 500 μm, more preferably less than 250 μm, even more preferably from 30 to 200 μm, still more preferably from 50 to 150 μm. Having the overall thickness falling within the above range, the multilayer film may have excellent transparency.

The thickness of the oxygen-absorbable resin composition layer may be generally from 1 to 50 μm or so, preferably from 5 to 30 μm or so.

The thickness of the gas-barrier material layer may be generally from 5 to 50 μm or so, preferably from 10 to 50 μm or so.

The thickness of the sealing material layer may be generally from 10 to 150 μm or so, preferably from 20 to 100 μm or so.

When each of the constitutive layers is too thin, then the thickness of the multilayer film may be uneven and the rigidity and the mechanical strength thereof may be insufficient. When too thick or too thin, the heat-sealable resin could not exhibit the heat sealability.

The method for producing the oxygen-absorbable multilayer film of the invention is not particularly limited. Single-layer films for the individual layers to constitute the multilayer film may be prepared and these may be laminated; or the multilayer film may be directly formed.

The single-layer films may be produced in any known method. For example, according to a solution-casting method that comprises dissolving the resin composition or the like for forming the constitutive layer in a solvent, then casting the solution onto an almost flat face and drying it thereon, the film may be obtained. In addition, for example, the resin composition or the like for forming the constitutive layer may be melt-kneaded in an extruder, then extruded out through a T-die, a circular die (ring die) or the like to give a predetermined shape, thereby producing a T-die film and a blown film and the like. As the extruder, usable is a kneading machine such as a single-screw extruder, a twin-screw extruder or a Banbury mixer. The T-die film may be biaxially stretched to give a biaxially stretched film.

The single-layer films produced in the manner as above may be formed into a multilayer film according to an extrusion coating method, a sandwich lamination method or a dry lamination method.

For producing the multilayer extrusion film, employable is a known coextrusion method; and for example, the extrusion may be carried out in the same manner as above except that the same number of extruders as that of the types of the resins are used and a multilayer multi-lamination die is used.

The coextrusion method includes a coextrusion lamination method, a coextrusion film forming method, a coextrusion inflation method, and the like.

One example is shown. According to a water-cooling or air-cooling inflation method, the resins to constitute respectively a gas-barrier material layer, an oxygen absorbent layer and a sealing material layer are separately heated and melted in different extruders, then extruded out through a multilayer cylindrical die at an extrusion temperature of, for example, from 190 to 210° C., and immediately quenched for solidification with a liquid coolant such as cooling water, thereby giving a tubular resin laminate.

In producing the multilayer film, the temperature of the ingredients to constitute the film layers such as the oxygen-absorbable resin composition and others is preferably from 160 to 250° C. When it is lower than 160° C., the layer thickness may be uneven and the film may be cut; but when higher than 250° C., the film may also be cut. More preferably, the temperature is from 170 to 230° C.

The film take-up speed in producing the multilayer film may be generally from 2 to 200 m/min, preferably from 50 to 100 m/min. When the take-up speed is too low, then the production efficiency may be poor; but when it is too high, then the film could not be sufficiently cooled and may be fused during taking up.

In case where the gas-barrier material layer film is comprised of a stretchable material and its properties could be enhanced by stretching, as in the case of polyamide resins, polyester resins, polypropylene and the like, then the multilayer film obtained through coextrusion may be further uniaxially or biaxially stretched. If desired, it may be further heat-set.

The draw ratio in stretching is not particularly limited and may be generally from 1 to 5 times in both the machine direction (MD) and the transverse direction (TD), preferably from 2.5 to 4.5 times in both MD and TD.

The stretching may be carried out in a known method of tenter stretching, inflation stretching, roll stretching or the like. The stretching may be carried out in any order of MD stretching or TD stretching; however, it is preferably carried out at the same time for MD and TD stretching. A tubular simultaneous biaxial stretching method may be employed.

The gas-barrier material layer may be subjected to front surface printing or rear surface printing or the like with a desired printing pattern, for example, letters, figures, symbols, designs, patterns and the like by an ordinary printing method.

The shape of the oxygen-absorbable multilayer film of the invention is not particularly limited, and the film may be any of a flat film, an embossed film or the like.

The oxygen-absorbable multilayer film of the invention is useful as a packaging material.

The packaging material comprised of the oxygen-absorbable multilayer film of the invention can be shaped into various forms of packaging containers and used.

Regarding the forms of the packaging containers obtainable from the packaging material of the invention, there may be mentioned casings, bags, or the like.

Regarding the forms of the packaging materials obtainable from the multilayer film of the invention, there may be mentioned ordinary, three-side sealed or four-side sealed pouches, gusseted pouches, standing pouches, pillow packaging bags, or the like. In case where the oxygen-absorbable multilayer film is a flat film, it may be formed into a packaging material having a desired shape according to an ordinary method; and in case where the film is in the form of a tubular laminate, it may be formed into a casing or a bag directly as it is.

The packaging material of the invention may be reheated at a temperature not higher than the melting point of the resins constituting it, and then uniaxially or biaxially stretched according to a thermoforming method of, for example, drawing, or according to a roll stretching method, a pantographic stretching method, an inflation stretching method or the like, thereby giving a stretched article.

The packaging container obtained from the packaging material that comprises the oxygen-absorbable molded article of the invention is effective for preventing the contents therein from being deteriorated by oxygen and for improving the shelf life thereof. The contents to be filled in the container are, for example, foods such as rice cakes, ramen, fruits, nuts, vegetables, meat products, baby foods, coffee, edible oil, sauces, shellfishes boiled in sweetened soy sauce, milk products, Japanese and western-style sweets; drugs; cosmetics; electronic materials; medical equipment; packaging materials for silver or iron parts; chemicals such as adhesives and sticking agents; miscellaneous goods such as chemical body warmers; or the like.

### EXAMPLES

The invention is described more concretely with reference to the following Production Examples and Examples. Unless otherwise specifically indicated, part and % in all Examples are by weight.

The properties of the samples were evaluated according to the following methods.

### [Weight-Average Molecular Weight (Mw) of Cyclized Product of Conjugated Diene Polymer]

This is determined as a molecular weight in terms of polystyrene by gel permeation chromatography.

### [Unsaturated Bond Reduction Ratio of Cyclized Product of Conjugated Diene Polymer]

This is determined by proton NMR analysis with reference to the methods described in the following references (i) and (ii).

(i) M. A. Golub and J. Heller. Can., J. Chem., Vol. 41, p. 937 (1963).

(ii) Y. Tanaka and H. Sato, J. Polym. Sci.: Poly. Chem. Ed., Vol. 17, p. 3027 (1979).

In the conjugated diene monomer unit segment in a conjugated diene polymer, when the overall proton peak area and the peak area of the protons directly bonding to the double bond before cyclization are represented by SBT and by SBU, respectively, and the overall proton peak area and the peak area of the protons directly bonding to the double bond after cyclization are represented by SAT and by SAU, respectively, then the peak area ratio (SB) of the protons directly bonding to the double bond before cyclization is:

SB=SBU/SBT,

and the peak area ratio (SA) of the protons directly bonding to the double bond after cyclization is:

SA=SAU/SAT.

Accordingly, the unsaturated bond reduction ratio is determined according to the following expression:

Unsaturated bond reduction ratio (%)=100×(SB−SA)/SB.

### [Glass Transition Temperature]

Using a differential scanning calorimeter (Seiko Instruments' trade name, “EXSTR6000 DSC”), this is determined in a nitrogen flow at a temperature-raising speed of 10° C./min.

### [Formation of Oxygen-Absorbable Film]

A T-die and a biaxial stretch tester (both by Toyo Seiki Seisakusho) were connected to a laboratory plastomill single-screw extruder, and pellets of an oxygen-absorbable resin composition are extruded and shaped into a film having a width of 100 mm and a thickness of 25 μm.

[Oxygen Absorption Rate (cc/g·day) of Oxygen-Absorbable Film]

An oxygen-absorbable film is cut into a size of 100 mm×100 mm, and put into an aluminum pouch having a size of 300 mm×400 mm (Sakura Bussan's trade name “Hiretort Alumi ALH-9), then air inside it is completely removed, and 200 cc of air having an oxygen concentration of 20.7% is sealed up therein, stored at 25° C. for 30 days, and then the oxygen concentration inside the pouch is measured with an oxygen densitometer (US Ceramatic's trade name “Food Checker HS-750”). From the thus-measured oxygen concentration and the oxygen concentration, 20.7% before the start of the test, the oxygen absorption rate is computed. Samples having a larger value measured in the manner are more excellent in the oxygen absorption rate.

### [Oxygen Permeation Rate of Oxygen-Absorbable Barrier Film]

According to the differential pressure method of JIS K7126 and using a differential pressure gas/vapor permeability measuring device (differential pressure gas permeation device: GTR Tec's “GTR-30×AD2”, detector: Yanaco Technical Science's “G2700T.F”), the sample is analyzed at a temperature of 23±2° C. and a relative humidity of 65% or 90%. The shape of the permeable face of the sample is a circle having a diameter of 4.4 cm, and the data are converted into those through a sample having a thickness of 20 μm. The unit of the data is cc/m²·day·atm (20 μm).

[Smell Level after Oxygen Absorption]

An oxygen-absorbable film is cut into a size of 100 mm×100 mm, and put into an aluminum pouch having a size of 300 mm×400 mm (Sakura Bussan's trade name “Hiretort Alumi ALH-9), then air inside it is completely removed, and 200 cc of air having an oxygen concentration of 20.7% is sealed up therein, stored at 60° C. for 7 days, and then the smell level in the pouch is determined. Five panelists smell and evaluate it according to the following criteria, and their points are averaged to be a smell level.

Point 1: No smell at all.

Point 2: Only slight smells.

Point 3: Some but a few acid smells.

Point 4: strong acid smells.

Point 5: Very strong acid smells.

### [Oxygen Absorbability of Oxygen-Absorbable Multilayer Film]

A polypropylene (MFR=6.9, Idemitsu Petrochemical's trade name, “F-734NP”) is formed into an unstretched polypropylene film having a thickness of 30 μm. An ethylene/vinyl alcohol copolymer (MFR=5.5, ethylene ratio 44 mol %, Kuraray's trade name, “Eval E105B”) is formed into a gas-barrier material layer film having a thickness of 20 μm.

These films are layered in an order of unstretched polypropylene film/oxygen-absorbable resin composition film/gas-barrier material layer film, and laminated, using a hot roll laminator (Gmp's trade name, “EXCELAM II 355Q”) set at 125° C.

The obtained laminate film is cut into a size having a length of 400 mm and a width of 100 mm and folded in two in such a manner that the sealing material layer could face inside, and its two sides are heat-sealed to form a bag having a size of 200 mm×100 mm. 100 cc of air having an oxygen concentration of 20.7% is put into the bag and sealed up therein by heat-sealing the remaining sides of the bag.

This is left at 23° C. for 5 days, and then the oxygen concentration in the bag is measured with an oxygen densitometer (US Ceramatic's trade name “Food Checker HS-750”).

The lower the oxygen concentration in the bag after left for 5 days is, the better oxygen absorbability the oxygen-absorbing multilayer film has.

### Production Example 1

### Production of Cyclized Product (I) of Conjugated Diene Polymer

300 parts of polyisoprene (cis-1,4-bond structure unit content, 73%; trans-1,4-bond structure unit content, 22%; 3,4-bond structure unit content, 5%; weight-average molecular weight, 154,000) cut into 10 mm square pieces were put into a pressure-resistant reactor equipped with a stirrer, a thermometer, a reflux condenser and a nitrogen gas inlet tube, along with 700 parts of cyclohexane. The reactor was purged with nitrogen. The contents were heated at 75° C., and with stirring, polyisoprene was completely dissolved in cyclohexane, and thereafter 3.0 parts of p-toluenesulfonic acid having a water content of at most 150 ppm, as a 15% toluene solution thereof, was put into it to carry out cyclization at a temperature not higher than 80° C. After continuation of the reaction for 7 hours, aqueous 25% sodium carbonate solution containing 1.16 parts of sodium carbonate was put into it to stop the reaction. Then at 80° C., water was removed by azeotropic refluxing dehydration, and thereafter the catalyst residue was removed from the reaction liquid through a glass fiber filter having a pore size of 2 μm.

To the obtained, cyclized polyisoprene solution, added were thiodiethylene-bis[3-(3,5-di-t-butyl-4-hydroxyphenyl) propionate] (Ciba Specialty Chemicals' trade name, “Irganox 1010”) in an amount corresponding to 150 ppm relative to the cyclized polyisoprene, and tris(2,4-di-t-butylphenyl) phosphite (Ciba Specialty Chemicals' trade name, “Irgafos 168”) in an amount corresponding to 1,000 ppm; then a part of cyclohexane in the solution was evaporated away, and toluene was removed by vacuum drying, thereby giving a solid cyclized polyisoprene (I). The unsaturated bond reduction ratio of the cyclized polyisoprene (I) was 71.7%, the weight-average molecular weight thereof was 142,000, and the glass transition temperature thereof was 79° C.

The cyclized polyisoprene (I) was pelletized into round pellets, using a single-screw kneading extruder (40 φ, L/D=25, die diameter 3 mm×1 hole, by Ikegai) under the kneading condition of cylinder 1: 140° C., cylinder 2: 150° C., cylinder 3: 160° C., cylinder 4: 170° C., and screw revolution speed: 25 rpm, thereby giving cyclized polyisoprene pellets (a).

### Production Example 2

### Production of Cyclized Product (II) of Conjugated Diene Polymer

8,000 parts of cyclohexane, 320 parts of styrene and an n-butyllithium/hexane solution containing 19.9 mmol of n-butyllithium and having a concentration of 1.56 mol/liter were fed into an autoclave equipped with a stirrer, then heated to have an inner temperature of 60° C., and polymerized for 30 minutes. The conversion of styrene in polymerization was about 100%. A part of the polymerization solution was sampled, and analyzed for the weight-average molecular weight of the obtained polystyrene, which was 14,800.

Next, with controlling the inner temperature so as not to be higher than 75° C., 1,840 parts of isoprene were continuously added to it over 60 minutes. After the completion of the addition, the reaction was further continued at 70° C. for 1 hour. At this point, the conversion in polymerization was about 100%.

To the polymerization solution, added was 0.362 part of an aqueous 1% solution of β-naphthalenesulfonic acid/formalin condensate sodium salt to stop the polymerization. Next, cyclohexane was removed, and a polystyrene/polyisoprene diblock copolymer comprising a polystyrene block and a polyisoprene block was obtained.

A part of this was sampled, and analyzed for the weight-average molecular weight thereof, which was 178,000.

300 parts of the block copolymer were dissolved in 900 parts of cyclohexane, and 4.2 parts of p-toluenesulfonic acid having a water content of at most 150 ppm, as a 15% toluene solution thereof, was put into it to carry out cyclization with controlling the temperature so as not to be higher than 80° C. After the reaction was continued for 7 hours, an aqueous 25% sodium carbonate solution containing 2.58 parts of sodium carbonate was put into it to stop the cyclization, and agitation was further continued for 30 minutes at 80° C. The obtained cyclized product of the diblock copolymer was filtered through a glass fiber filter having a pore size of 1 μm to remove the catalyst residue from the reaction liquid, thereby giving a solution containing the cyclized product of the polystyrene/polyisoprene diblock copolymer.

To the obtained solution of the cyclized product of the diblock copolymer, added was thiodiethylene-bis[3-(3,5-di-t-butyl-4-hydroxyphenyl) propionate] (Ciba Specialty Chemicals' trade name, “Irganox 1010”) in an amount corresponding to 150 ppm relative to the cyclized product of the diblock copolymer, and tris(2,4-di-t-butylphenyl) phosphite (Ciba Specialty Chemicals' trade name, “Irgafos 168”) in an amount corresponding to 1,000 ppm; cyclohexane in the solution was removed, and then toluene was removed by vacuum drying, thereby giving a solid cyclized product of the diblock copolymer (II) in which the polyisoprene segment was cyclized. The unsaturated bond reduction ratio of the cyclized product of the diblock copolymer (II) was 70.8%, the weight-average molecular weight thereof was 141,000, and the glass transition temperature of the cyclized polyisoprene segment was 76° C.

The cyclized product of the diblock copolymer (II) was pelletized into round pellets, using a single-screw kneading extruder (40 φ, L/D=25, die diameter 3 mm×1 hole, by Ikegai) under the kneading condition of cylinder 1: 140° C., cylinder 2: 150° C., cylinder 3: 160° C., cylinder 4: 170° C., die temperature; 170° C., and screw revolution speed: 25 rpm, thereby giving pellets (b) of the cyclized product of the diblock copolymer.

### Examples 1 to 4, Comparative Examples 1 to 3

### Formation of Oxygen-Absorbable Resin Composition Pellets

The pellets (a) of the cyclized product of the conjugated diene polymer or pellets (b) of the cyclized product of the polystyrene/polyisoprene diblock copolymer, and liquid paraffin or liquid paraffin/LLDPE (Nippon Polystyrene's trade name “NF464”) were blended in the blend ratio as shown in Table 1, using a twin-screw kneading extruder (Berstorf's trade name, “ZE40A”, 43 φ, L/D=33.5) under the kneading condition of cylinder 1: 145° C., cylinder 2: 175° C., cylinder 3: 190° C., cylinder 4: 190° C., die temperature; 190° C., and screw revolution speed: 25 rpm, thereby giving pellets P1 to P4 and PC1 to PC3 of an oxygen-absorbable resin composition comprising an oxygen-absorbable resin (A) having a cycloene structure in the molecule and a softener (B).

The compositions of these pellets are shown in Table 1.

These pellets P1 to P4 and PC1 to PC3 were formed into oxygen-absorbable films F1 to F4 and FC1 to FC3, respectively.

The oxygen-absorbable film F was produced by press-molding pellets of the oxygen-absorbable resin composition at 150° C. on a polyethylene terephthalate film (thickness 50 μm). Its thickness was 35 μm.

The oxygen-absorbable films were evaluated for the oxygen absorption rate and the smell level after oxygen absorption.

The results are shown in Table 1.

### Examples 5 to 8, Comparative Examples 4 to 6

The oxygen-absorbable films F1 to F4 and FC1 to FC3 obtained in Examples 1 to 4 and Comparative Examples 1 to were, as laminated with an unstretched polypropylene film and a barrier film, formed into oxygen-absorbable multilayer films MF1 to MF4 and MFC1 to MFC3, respectively.

These oxygen-absorbable multilayer films were evaluated for the oxygen absorbability, and the results are shown in Table 1.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Pellets | P1 | P2 | P3 | P4 | PC1 | PC2 | PC3 |
| Cyclized product of | 75 | 40 | — | — | 100 | 90 | — |
| conjugated diene | | | | | | | |
| polymer (I) | | | | | | | |
| Cyclized product of | — | — | 80 | 50 | — | — | 80 |
| conjugated diene | | | | | | | |
| polymer (II) | | | | | | | |
| Liquid paraffin (*1) | 25 | — | 20 | — | — | 10 | — |
| Liquid paraffin (*2, | — | 12 | — | 10 | — | — | 4 |
| *4) | | | | | | | |
| LLDPE (*3, *4) | — | 48 | — | 40 | — | — | 16 |
| Glass transition | 8 | 15 | 20 | 28 | 76 | 48 | 60 |
| temperature (° C.) | | | | | | | |
| Oxygen-absorbable film | F1 | F2 | F3 | F4 | FC1 | FC2 | FC3 |
| Oxygen absorption rate | 11.5 | 5.2 | 9.5 | 5.1 | 0 | 0.8 | 0.3 |
| (cc/g · day) | | | | | | | |
| Smell level | 1.8 | 1.5 | 1.5 | 1.3 | 1.8 | 1.8 | 1.7 |
| | | | | | Comparative | Comparative | Comparative |
| | Example 5 | Example 6 | Example 7 | Example 8 | Example 4 | Example 5 | Example 6 |
| Oxygen-absorbable | MF1 | MF2 | MF3 | MF4 | MFC1 | MFC2 | MFC3 |
| multilayer film | | | | | | | |
| Oxygen concentration in | 3.1 | 4.6 | 8.1 | 13.5 | 20.7 | 20.7 | 20.7 |
| pouch (%) | | | | | | | |

(*1): Kaneda's trade name “HiCall K-350”, having a viscosity of about 75 cSt (37.8° C.).
(*2): Matsumura Petroleum Laboratory's trade name “Moresco White P-350”, having viscosity of about 67 cSt (40° C.).
(*3): Nippon Polystyrene's trade name “NF464”.
(*4): Added as a mixture of LLDPE/liquid paraffin = 80/20.

From the results in Table 1, it is shown that the oxygen-absorbable film obtained from an oxygen absorbent, which comprises only an oxygen-absorbable resin (A) having a cycloene structure in the molecule but does not contain a softener (B), has poor oxygen absorbability at 25° C., and that the oxygen-absorbable multilayer film obtained from it has poor oxygen absorbability at 23° C. (Comparative Examples 1, 2, 4 and 5).

Even though containing a softener (B), the oxygen-absorbable film and the oxygen-absorbable multilayer film obtained from an oxygen-absorbable resin composition having a glass transition temperature of higher than 30° C. also have poor oxygen absorbability at 23° C. and 25° C. (Comparative Examples 3 and 6).

It is shown, on the contrary, that the oxygen-absorbable film obtained from the oxygen-absorbable resin composition of the invention, which comprises an oxygen-absorbable resin (A) having a cycloene structure in the molecule and a softener (B) and which has a glass transition temperature of not higher than 30° C., exhibits excellent oxygen absorbability at 25° C., and that the oxygen-absorbable multilayer film obtained from it exhibits excellent oxygen absorbability at 23° C. (Examples 1 to 8).

### Examples 9 to 12, Comparative Examples 7 to 9

### Formation of Oxygen-Absorbable Resin Composition Pellets

The pellets (a) of the cyclized product of the conjugated diene polymer or pellets (b) of the cyclized product of the polystyrene/polyisoprene diblock copolymer, and liquid paraffin or liquid paraffin/LLDPE (Nippon Polystyrene's trade name “NF464”), and an ethylene/vinyl alcohol copolymer (ethylene content 44 mol %, Kuraray's trade name, “E105B”) were blended in the blend ratio as shown in Table 2, using a twin-screw kneading extruder (Berstorf's trade name, “ZE40A”, 43 φ, L/D=33.5) under the kneading condition of cylinder 1: 150° C., cylinder 2: 200° C., cylinder 3: 200° C., cylinder 4: 200° C., die temperature; 200° C., and screw revolution speed: 150 rpm, thereby giving pellets P9 to P13 and PC7 to PC9 of an oxygen-absorbable resin composition comprising an oxygen-absorbable resin (A) having a cycloene structure in the molecule, a softener (B), and a gas-barrier resin (C). The compositions of these pellets are shown in Table 2.

The oxygen-absorbable resin composition may have also a glass transition temperature based on the ethylene/vinyl alcohol copolymer therein; but in the Table, only the data are shown, based on the oxygen-absorbable resin composition (cycloene structure-having oxygen-absorbable resin (A) and softener (B)).

### Examples 13 to 14, Comparative Examples 10 to 11

Of the above-mentioned pellets, those of P11, P12, PC8 and PC9 were blended with an ethylene/vinyl alcohol copolymer (MFR=5.5 (190° C., 2.16 kg), ethylene content 44 mol %, Kuraray's trade name “E105B”) in the ratio as shown in Table 2, thereby giving blend pellets BP11, BP12, BPC8 and BPC9, respectively.

TABLE 2

| | | | | | Comparative | Comparative | Comparative |
|---|---|---|---|---|---|---|---|
| | Example 9 | Example 10 | Example 11 | Example 12 | Example 7 | Example 8 | Example 9 |
| Pellets | P9 | P10 | P11 | P12 | PC7 | PC8 | PC9 |
| Cyclized product of | 33 | 18 | — | — | 40 | 90 | — |
| conjugated diene | | | | | | | |
| polymer (I) | | | | | | | |
| Cyclized product of | — | — | 80 | 40 | — | — | 80 |
| conjugated diene | | | | | | | |
| polymer (II) | | | | | | | |
| Liquid paraffin (*1) | 7 | — | 20 | — | — | 10 | — |
| Liquid paraffin (*2, *4) | — | 5.2 | — | 12 | — | — | 4 |
| LLDPE (*3, *4) | — | 20.8 | — | 48 | — | — | 16 |
| EVOH (*5) | 60 | 56 | — | — | 60 | — | — |
| Glass transition | 24 | 21 | 17 | 20 | 76 | 48 | 60 |
| temperature (° C.) | | | | | | | |

| | | | Comparative | Comparative |
|---|---|---|---|---|
| | Example 13 | Example 14 | Example 10 | Example 11 |
| Blend pellets | BP11 | BP12 | BPC8 | BPC9 |
| Pellets | | | | |
| P11 | 30 | — | — | — |
| P12 | — | 20 | — | — |
| PC8 | — | — | 40 | — |
| PC9 | — | — | — | 40 |
| EVOH (*5) | 70 | 80 | 60 | 60 |
| Glass transition | 17 | 20 | 46 | 59 |
| temperature (° C.) | | | | |

(*1): Kaneda's trade name “HiCall K-350”, having a viscosity of about 75 cSt (37.8° C.).
(*2): Matsumura Petroleum Laboratory's trade name “Moresco White P-350”, having viscosity of about 67 cSt (40° C.).
(*3): Nippon Polystyrene's trade name “NF464”.
(*4): Added as a mixture of LLDPE/liquid paraffin = 80/20.
(*5): Ethylene/vinyl alcohol copolymer (Kuraray's trade name, “E105B”).

### Examples 15 to 18, Comparative Examples 12 to 14, Reference Example

These pellets P9, P10, BP11, BP12, PC7, BPC8 and PBC9 were formed into oxygen-absorbable barrier films F9 to F12 and FC7 to FC9, respectively.

A barrier film FC10 comprised of only the ethylene/vinyl alcohol copolymer (MFR=5.5, ethylene content 44 mol %, Kuraray's trade name “E105B”) was formed.

These oxygen-absorbable barrier films were evaluated for the oxygen permeability and the smell level after oxygen absorption.

The results are shown in Table 3.

TABLE 3

| | Example | Example | Example | Example |
|---|---|---|---|---|
| | 15 | 16 | 17 | 18 |
| (Blend) Pellets | P9 | P10 | P11 | P12 |
| Oxygen-absorbable | F9 | F10 | F11 | F12 |
| barrier film | | | | |
| Oxygen permeability | | | | |
| (cc/m² · day · atm) | | | | |
| 65% RH | 0.1 | 0.3 | 0.5 | 0.4 |
| 90% RH | 0.3 | 0.5 | 0.8 | 1.1 |
| Smell level | 1.8 | 1.5 | 1.5 | 1.3 |
| | Compara | Compara- | Compara- | |
| | tive | tive | tive | Refer- |
| | Example | Example | Example | ence |
| | 12 | 13 | 14 | Example |
| | PC7 | BPC8 | BPC9 | — |
| Oxygen-absorbable | FC7 | FC8 | FC9 | FC10 |
| barrier film | | | | |
| Oxygen permeability | | | | |
| (cc/m² · day · atm) | | | | |
| 65% RH | 5.8 | 5.1 | 5.4 | 3.5 |
| 90% RH | 13.5 | 13.8 | 14.1 | 13.2 |
| Smell level | 1.9 | 2.1 | 1.8 | 1.6 |

From the results in Table 3, it is shown that the oxygen-absorbable barrier film obtained from an oxygen-absorbable resin composition, which comprises only an oxygen-absorbable resin (A) having a cycloene structure in the molecule and a gas-barrier resin (C) but does not contain a softener (B), has a high oxygen permeability (Comparative Example 12).

It is shown that, even though containing a softener (B), the oxygen-absorbable barrier film obtained from an oxygen-absorbable resin composition having a glass transition temperature of higher than 30° C. also has a high oxygen permeability (Comparative Examples 13 and 14).

It is shown, on the contrary, that the oxygen-absorbable barrier film obtained from the oxygen-absorbable resin composition of the invention, which comprises an oxygen-absorbable resin (A) having a cycloene structure in the molecule and a softener (B) and which has a glass transition temperature of not higher than 30° C., has an extremely low oxygen permeability (Examples 15 to 18).

1. An oxygen-absorbable resin composition that includes an oxygen-absorbable resin (A) having a cycloene structure in the molecule and a softener (B) and has a glass transition temperature of not higher than 30° C.

2. The oxygen-absorbable resin composition as claimed in claim 1, wherein the oxygen-absorbable resin (A) having a cycloene structure in the molecule is a cyclized product of a conjugated diene polymer having an unsaturated bond reduction ratio of at least 60%.

3. The oxygen-absorbable resin composition as claimed in claim 1 or 2, wherein the softener (B) is liquid paraffin or polybutene.

4. The oxygen-absorbable resin composition as claimed in claim 1, which further includes a poly-α-olefin resin.

5. The oxygen-absorbable resin composition as claimed in claim 1, which has an oxygen absorption rate at 25° C. of at least 0.3 cc/g·day.

6. An oxygen-absorbable molded article including the oxygen-absorbable resin composition of claim 1.

7. The oxygen-absorbable molded article as claimed in claim 6, which has a form of a film.

8. An oxygen-absorbable molded article having a layer including the oxygen-absorbable resin composition of claim 1.

9. The oxygen-absorbable molded article as claimed in claim 8, which has a form of a multilayer film.

10. The oxygen-absorbable molded article as claimed in claim 9, which further has an oxygen-barrier layer.

11. An oxygen-absorbable packaging material comprising the molded article of claim 6.

12. An oxygen-absorbable packaging container produced by shaping the oxygen-absorbable packaging material of claim 11.

13. An oxygen-absorbable barrier resin composition comprising the oxygen-absorbable resin composition of claim 1 and a gas-barrier resin (C).

14. The oxygen-absorbable barrier resin composition as claimed in claim 13, wherein the gas-barrier resin (C) has an oxygen permeation rate of from 0.15 to 20 cc/m²·day·atm (20 μm, 23° C., 65% RH).

15. The oxygen-absorbable barrier resin composition as claimed in claim 13, wherein the gas-barrier resin (C) is an ethylene/vinyl alcohol copolymer.

16. An oxygen-absorbable molded article including the oxygen-absorbable barrier resin composition of claim 13.

17. The oxygen-absorbable molded article as claimed in claim 16, which has a form of a film.

18. An oxygen-absorbable molded article having a layer including the oxygen-absorbable barrier resin composition of claim 13.

19. The oxygen-absorbable molded article as claimed in claim 18, which has a form of a multilayer film.

20. An oxygen-absorbable packaging material comprising the oxygen-absorbable molded article of claim 16.

21. An oxygen-absorbable packaging container produced by shaping the packaging material of claim 20.
